(19) United States
(12) Patent Application Publication
(10) Pub. No.: US 2006/0125768 A1
(43) Pub. Date: Jun. 15, 2006

(54) Light source device for image display device

(76) Inventor: Seijiro Tomita, Tokyo (JP)

Correspondence Address: ARMSTRONG, KRATZ, QUINTOS, HANSON & BROOKS, LLP, 1725 K STREET, NW, SUITE 1000, WASHINGTON, DC, 20006, US

(21) Appl. No.: 10/535,623

(22) PCT Filed: Nov. 20, 2002
(86) PCT No.: PCT/JP02/12127

§ 371 Date: Dec. 2, 2005

(51) Int. Cl. G09G 3/36

(52) U.S. Cl. 345/102

(57) ABSTRACT

A highly precise and durable light source device 10 for a two-dimensional or planar image display does not use a mechanical construction and thus can rapidly move an illuminating point on a light source to a position that best matches the positional movement of an observer. The light source device is provided with an image display means 12. The light source device also includes an LED array 11 of white LEDs 1 or RGB LEDs and an LED control means 13 for performing a turn-on control on the white LEDs in the LED array.

### BACKGROUND OF THE INVENTION

1. Field of the Invention

The present invention relates to a light source device for display which rapidly turns on a small number of LEDs to present an image to an observer in a wide range of viewing angle even if the observer moves sideways or the image is looked at by two or more observers from multiple visual points. More particularly, the invention relates to a light source device for display that has an image display means for creating an image using transmitted light.

2. Description of the Prior Art

An example of conventional display that forms a planar or two-dimensional image is shown in FIG. 4. In this display, light from a light source 65 constructed, for example, of a fluorescent lamp is projected onto a liquid crystal device 62 by a diffusing lens 63 and arranged for image forming. Displays in such arrangement have been known.

In this prior art, however, since a viewable range is limited, if the position of an observer is shifted sideways and up and down even slightly, he or she cannot see an image. A possible method to solve this problem may involve a method to expand the viewable range with the diffuser and so forth after having raised the number of the light source for increasing the luminance, but the method contributes to enlarge the display and increase the power consumption, and prevents from applying to a portable device. Further, a possible measure to deal with the above problem is a method of measuring the position of a viewer and mechanically moving the light source 65 according to the viewer's movement. This method has, however, difficulties because of its slow response speed, because a mechanically driving device easily wears out and lacks a sufficient durability, because the display becomes larger, and so forth.

The present invention has been accomplished under these circumstances. A primary object of this invention is to provide a light source device for display which can turn a light source on and off at a speed high enough to allow the light source to be turned off during synchronization signal and blanking periods to eliminate unwanted afterimages and interferences and reduce power consumptions. In this invention, a control for turning off the light source during the synchronization signal and blanking periods is referred to as a turn-off control.

A second object of this invention is to provide a light source device for display which has high precision and durability and can present a clear image to an observer irrespective of a positional movement of the observer without using a mechanical construction. In this invention, a control to move the position of an illuminating point on a light source is referred to as a turn-on control.

A third object of this invention is to provide a light source device for display which, with a limited number of LEDs as a light source, can form a wide viewing angle image on a display. In this case, by using a known tracking device, such as an ultrasonic tracking device, infrared tracking device or image tracking device, it is possible to create a bright, clear, planar image even if eyes of an observer move or the display is viewed by two or more observers.

### SUMMARY OF THE INVENTION

The present invention solves the aforementioned problems by the following means.

A first aspect of the present invention provides a light source device for display having an image display means, wherein the image display means forms an image using transmitted light, the light source device comprising: a LED array having a plurality of white LEDs or RGB LEDs arranged in array, the white LEDs or RGB LEDs being arranged so as to synchronize with an image signal to have a turn-on and turn-off controlled at high speed.

A second aspect of the present invention provides a light source device for display according to the first aspect, wherein a convex lens or a Fresnel lens is arranged between the light source according to the first aspect and a liquid crystal display; and the LEDs are arranged in a linear configuration, an arc configuration, a cross configuration, a radial configuration, a circular or polygonal configuration made up of a plurality of similar shapes, or in a spiral configuration.

A third aspect of the present invention provides a light source device for display based on the technology of the light source device for display according to the first or second aspect, wherein the LEDs are turned on and scanned at high speed in vertical and horizontal directions.

A fourth aspect of the present invention provides a light source device for display based on the technology of the light source device for display according to the second or third aspect, wherein the display has a position identifying means which measures a position of an observer relative to the display and outputs a corresponding position signal, and a means for controlling a LED turn-on performs a turn-on control on the white LEDs or RGB LEDs based on the position information so as to keep an image viewable by the observer.

A sixth aspect of the present invention provides a light source device for display based on the technology of the light source device for display according to the second or third aspect, wherein the display has a position identifying means which counts the number of observers, measures positions of the observers relative to the display and outputs corresponding position signals, and the means for controlling a LED turn-on performs a turn-on control on the white LEDs or RGB LEDs based on the position information so as to keep images viewable by the observers.

A seventh aspect of the present invention provides a light source device for display according to any one of the first to sixth aspects, wherein the display is used on displays of television sets, game machines, personal computers, cell phones or mobile terminals.

### BRIEF DESCRIPTION OF THE DRAWINGS

FIG. 1 illustrates a display that uses a light source device for display according to a first embodiment of the invention.

FIG. 2 illustrates a display that uses a light source device for display according to a second embodiment of the invention.

FIG. 3 illustrates a display that uses a light source device for display according to a third embodiment of the invention.

FIG. 4 illustrates an example of a conventional display.

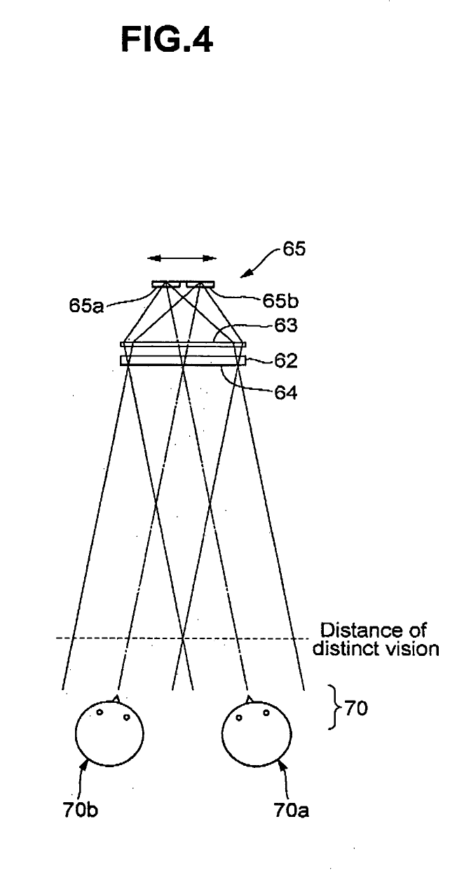

### DETAILED DESCRIPTION OF THE PREFERRED EMBODIMENT

Now, embodiments of the present invention will be described by referring to the accompanying drawings.

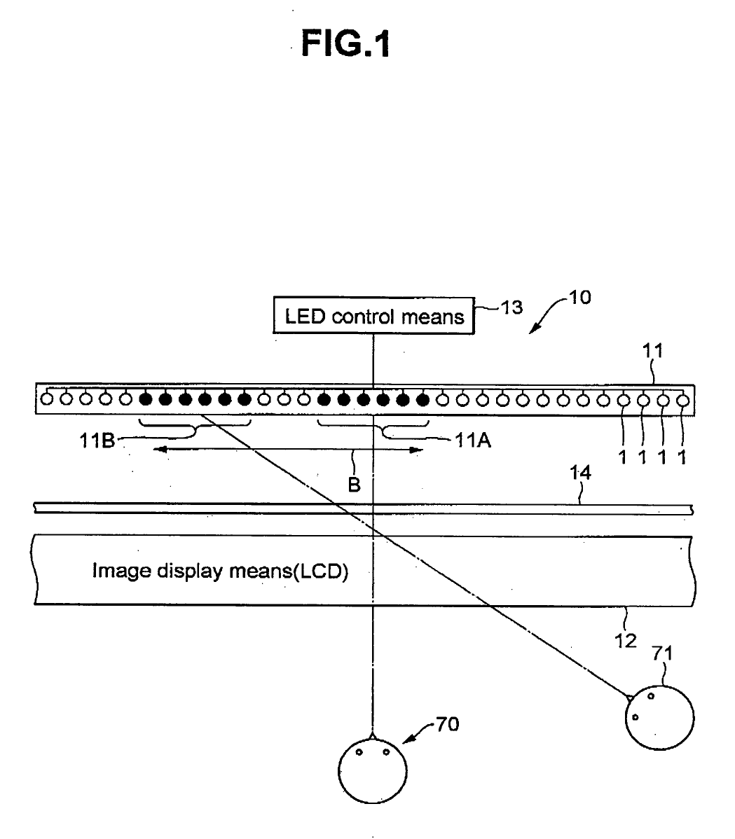

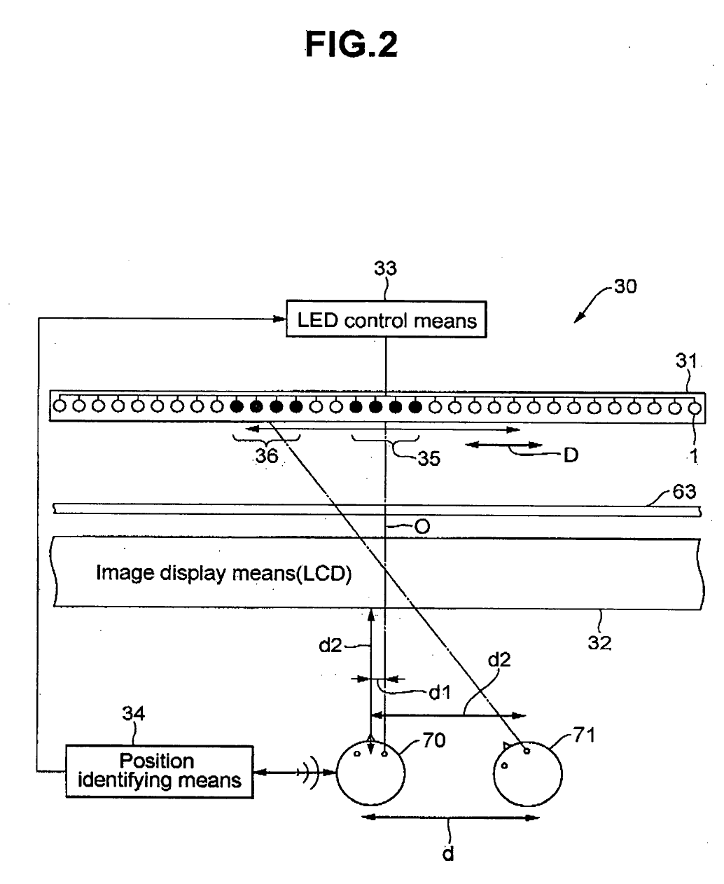

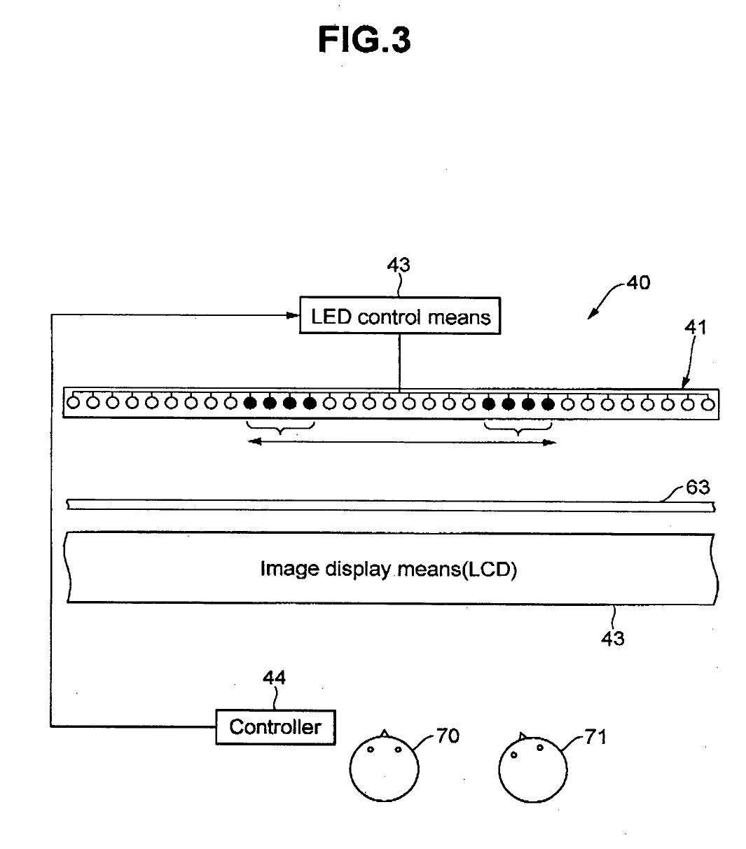

FIG. 1 to FIG. 3 show embodiments of this invention, FIG. 1 representing a first embodiment of the invention, FIG. 2a second embodiment and FIG. 3a third embodiment.

In the following description it is assumed that a display used is a two-dimensional display. When a light source is used on the two-dimensional display, a light transmission type liquid crystal display panel may be used as an image display means.

### First Embodiment

In this embodiment a light source device 10 for display is used on a two-dimensional display. As shown in FIG. 1, the light source device 10 includes an LED array 11 having a plurality of white LEDs 1 arranged in a plurality of horizontal, parallel rows, an image display means 12, and a Fresnel lens 14 acting as a convex lens. The image display means 12 may use a transmission type liquid crystal panel. Instead of the Fresnel lens, other convex lenses may be used.

The LED array 11 is turned on or off by an LED control means 13.

In this embodiment, the LED control means 13 quickly turns on and scans an illuminating region 11A of the white LEDs 1 in the LED array 11 to the left and right. In FIG. 1, lit LEDs are represented by black dots “•” and unlit LEDs by blank dots “∘” (this representation also applies in the following description). Positions of an observer 70 are denoted by 70 and 71.

By moving bands 11A, 11B of illuminating LEDs 1 in the LED array 11 in the direction of arrow B, the light source device, which uses a limited light source or a small number of LEDs in combination with the Fresnel lens 14, can produce an image with a wide viewing angle. Further, by performing the turn-off control that turns off the white LEDs 1 during the synchronization signal and blanking periods of the image display means 12, not only can unwanted afterimages and interferences be eliminated but the power consumption can also be reduced.

### Second Embodiment

In this embodiment, a light source device for display includes an LED array 31, an image display means 32, an LED control means 33, and a position identifying means 34 for measuring the position of an observer 70. The position identifying means 34 measures a displacement d1 of an observer from an optical axis 0 of the light source device and a distance d2 of the observer from the image display means 32 and issues a measurement signal. In this embodiment, the position identifying means 34 may be of an ultrasonic type, infrared type or any other desired type.

The LED control means 33 performs control to turn on an illuminating region 35, 36 of white LEDs 1 in the LED array 31 to rapidly move an illuminating point on the LED array 31 (indicated by an arrow D) to a position corresponding to a movement of the observer 70 (indicated by an arrow d), thus presenting a clear image to the observer at all times.

The fact that the control of the light source device 30 does not entail mechanical actions can not only ensure high speed, high precision and high durability but also simplify the construction of, for example, a servo control mechanism.

The position identifying means 34 identifies the number of viewers and measures their positions relative to the display, and then outputs corresponding position signals. Performing the turn-on control on the LED array 31 by the LED control means 33 can present appropriate planar images to two or more observers 70 and 71 lying at different positions.

### Third Embodiment

A light source device 40 for display in this embodiment uses a manual controller 44 in place of the position identifying means of the second embodiment. In this third embodiment, the controller 44, when operated by an observer 70, can cause the light source device to quickly move the illuminating region to a desired position, thus presenting an adequate planar image to the observer. This embodiment can simplify a control system and, since no mechanical actions are performed, can provide a high precision and a high durability.

The light source device according to this invention, though not limited to any particular use, may be used on displays of television sets, game machines, personal computers, cell phones and mobile terminals.

Although the LED array 11 in this embodiment is made up of white LEDs, each of the LEDs in the LED array may be formed by combining three primary color LEDs, or RGB LEDs, so that the RGB LEDs as a whole produce white light.

It should be noted that the light source device for display according to this invention is not limited in construction to the embodiments described above and that a variety of modifications may be made without departing from the spirit of the invention. For example, the LEDs on the LED array may be arranged in a cross configuration, a radial configuration, a circular or polygonal configuration consisting of a plurality of similar shapes, or in a spiral configuration. Further, the LED array may be arranged in an arc geometry in which a distance from the viewing point of the observer to any point on the LED array is constant.

### INDUSTRIAL APPLICABILITY

As described above, the light source device for display according to the present invention has the following advantages.

According to a first aspect of this invention, since a power consumption is small and white LEDs or RGB LEDs whose on-off switching speed is fast are used as a light source, the power consumption of the light source device can be further reduced, and since the light source is controlled synchronized with the image signal and is turned off during synchronization signal and blanking periods, unwanted afterimages and interferences can be eliminated.

According to a second aspect of this invention, it is possible to select a LED arrangement that matches a position of an object to be presented to an observer. In this manner, according to the invention, a plurality of LEDs may be arranged in a straight line or in any other configuration as a whole as long as they are arranged in a row. Further, the LEDs may also be arranged in multiple rows in accordance with the intended use.

According to a third aspect of this invention, a reduction of power consumption can be promoted by using a part of display which scans at high speed in vertical and horizontal directions to expand the viewing angle. Thus, in small displays used on cell phones and portable game machines which have a limited number of LEDs as a light source and in which an observer's viewing position relative to the display easily shifts, this invention can present a clear image to an observer wherever the observer is positioned with respect to the display, without having to detect the position of the observer. This eliminates a trouble, experienced with conventional liquid crystal displays, that an image on the display is difficult to see from a slant direction.

According to a fourth aspect of this invention, it is possible to quickly move the illuminating LEDs to a position on the display that best matches the observer's position, thus realizing a wide viewing angle. In this invention, since this movement is not performed mechanically, but by a LED turn-on control, no mechanical abrasion, an excellent durability, a high speed and a high precision can be obtained.

According to a sixth aspect of this invention, a reduction of power consumption is promoted and appropriate, clear images can be presented to the associated observers lying at different positions as well.

According to a seventh aspect of this invention, with a reduction of power consumption promoted, a wide viewing angle can be realized when observers see images on large displays of television sets, game machines and personal computers and also on small displays of cell phones and mobile terminals which can easily move relative to sight lines of the observers. In those small displays, such as used on cell phones and portable game machines, that use a limited number of LEDs as a light source and in which the viewing position of the observer can easily shift relative to the display, a clear image can be presented to an observer without detecting the position of the observer with a position detection means wherever he or she is positioned with respect to the display. Further, because the position detection is obviated, the control can be simplified significantly and the power consumption reduced.

1. A light source device for display having an image display means, wherein the image display means forms an image using transmitted light, the light source device comprising:
a LED array having a plurality of white LEDs or RGB LEDs arranged in array, and
the white LEDs or RGB LEDs being arranged so as to synchronize with an image signal to have a turn-on and turn-off controlled at high speed.

2. A light source device for display according to claim 1, wherein a convex lens or a Fresnel lens is arranged between the light source according to the claim 1 and a liquid crystal display; and the LEDs are arranged in a linear configuration, an arc configuration, a cross configuration, a radial configuration, a circular or polygonal configuration made up of a plurality of similar shapes, or in a spiral configuration.

3. A light source device for display according to claim 1, wherein the LEDs are turned on and scanned at high speed in vertical and horizontal directions.

4. A light source device for display according to claim 2, wherein the display has a position identifying means which measures a position of an observer relative to the display and outputs a corresponding position signal, and a means for controlling LED turn-on performs a turn-on control on the white LEDs or RGB LEDs based on the position information so as to keep an image viewable by the observer.

5. (canceled)

6. A light source device for display according to claim 2, wherein the display has a position identifying means which counts the number of observers, measures positions of the observers relative to the display and outputs corresponding position signals, and the means for controlling LED turn-on performs a turn-on control on the white LEDs or RGB LEDs based on the position information so as to keep images viewable by the observers.

7. A light source device for display according to claim 1, wherein the display is used on displays of television sets, game machines, personal computers, cell phones or mobile terminals.
